(19) United States
(12) Patent Application Publication
(10) Pub. No.: US 2006/0257679 A1
(43) Pub. Date: Nov. 16, 2006

(54) Polymeric optical body containing inorganic fibers

(76) Inventors: Olester Benson JR., Woodbury, MN (US); Patrick R. Fleming, Lake Elmo, MN (US); Andrew J. Ouderkirk, Woodbury, MN (US); Kristin L. Thunhorst, Stillwater, MN (US)

Correspondence Address: 3M INNOVATIVE PROPERTIES COMPANY, PO BOX 33427, ST. PAUL, MN, 55133-3427, US

(21) Appl. No.: 11/125,581

(22) Filed: May 10, 2005

(51) Int. Cl. B29B 7/00

(52) U.S. Cl. 428/542.8

(57) ABSTRACT

Optical bodies, for example optical films, are formed with inorganic fibers embedded within a polymer matrix. In some embodiments, the refractive indices of the inorganic fibers and the polymer matrix are matched. There need be no bonding agent between the fibers and the polymer matrix. The inorganic fibers may be glass fibers, ceramic fibers, or glass-ceramic fibers. A structure may be provided on the surface of the optical body, for example to provide optical power to light passing through the optical body. The body may be formed using a continuous process, with a continuous layer of the inorganic fibers being embedded within the matrix which is then solidified.

### FIELD OF THE INVENTION

The invention relates to polymer optical film and more particularly to polymer optical film that contains inorganic fibers for increased rigidity and stiffness.

### BACKGROUND

Optical films, thin polymer films whose optical properties are important to their function, are often used in displays, for example, for managing the propagation of light from a light source to a display panel. Light management functions include increasing the brightness of the image and increasing the uniformity of illumination across the image.

Such films are thin and, therefore, have little structural integrity. As display systems increase in size, the area of the films also becomes larger. Unless they are made thicker, the films may reach a size where they are not sufficiently stiff to maintain their shape. Making films thicker, however, increases the thickness of the display unit, and also leads to increases in the weight and in the optical absorption. The thicker films also increase thermal insulation, reducing the ability to transfer heat out of the display. Furthermore, there are continuing demands for displays with increased brightness, which means that more heat is generated with the display systems. This leads to an increase in the distorting effects that are associated with higher heating, for example film warping.

Currently, the solution to accommodate larger display sizes is to laminate the optical films to a much thicker substrate. This solution adds cost to the device, and makes the device thicker and heavier. The added cost does not, however, result in a significant improvement in the optical function of the display.

### SUMMARY OF THE INVENTION

One embodiment of the invention is directed to an optical body that includes a polymer matrix. The polymer matrix has a first refractive index. A plurality of fibers is embedded within the polymer matrix. The fibers are formed of a fiber material comprising at least one of a glass-ceramic and a ceramic. The fiber material has a second refractive index that is substantially the same as the first refractive index.

The above summary of the present invention is not intended to describe each illustrated embodiment or every implementation of the present invention. The following figures and the detailed description more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A schematically illustrates an optical film;

FIG. 1B schematically illustrates a cut-away view of an optical film according to principles of the present invention;

FIG. 2 presents a graph showing scattering efficiency as a function of fiber radius;

FIG. 3 schematically illustrates an embodiment of a fiber weave;

FIGS. 4A and 4B schematically illustrate exemplary embodiments of fiber yarn according to principles of the present invention;

FIGS. 5A-5C schematically illustrate cross-sectional views through fiber-reinforced films according to principles of the present invention;

FIG. 6 schematically illustrates cross-sectional view through a fiber-reinforced film having optical power, according to principles of the present invention;

FIGS. 7A-7D schematically illustrate cross-sectional views through fiber-reinforced films that have surface structure, according to principles of the present invention;

FIGS. 8A and 8B schematically illustrate systems that may be used for fabricating fiber-reinforced optical films according to principles of the present invention;

FIG. 9 schematically illustrates a system for impregnating a fiber layer with resin for making a fiber-reinforced optical film according to principles of the present invention; and

FIG. 10 schematically illustrates a system for molding a fiber-reinforced optical film according to principles of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is particularly applicable to optical display systems that use one or more optical films. As optical displays, for example liquid crystal displays (LCDs) become larger and brighter, the demands on optical films within the displays become greater. Larger displays require stiffer films, to prevent warping, bending and sagging. Scaling a film's thickness up with its length and width, however, leads to a thicker and heavier film. It is desirable, therefore, that optical films be made stiffer so that they can be used in large displays, without a concomitant increase in thickness. One approach for increasing the stiffness of the optical film is to include fibers within the film. In some exemplary embodiments, the fibers are matched in refractive index to the surrounding material of the film so that there is little, or no, scatter of the light passing through the film.

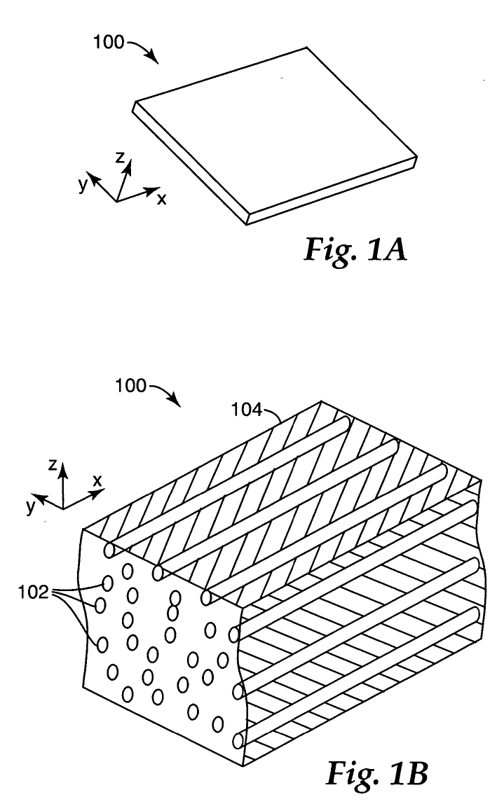

An embodiment of an optical element 100 is schematically illustrated in FIG. 1A, showing the element 100 relative to an arbitrarily assigned coordinate system. The element 100 has a thickness in the z-direction. A cross-section through part of the element 100 is schematically illustrated in FIG. 1B. The element comprises a polymer matrix 104, which may be referred to as a continuous phase. The element 100 is formed as a bulk optical body, and may, for example be in the form of a sheet or film, a cylinder, a tube or the like. The element 100 may have a sufficient cross-sectional dimension that the element 100 is substantially self-supporting in at least one dimension. For example, if the element 100 is a sheet having a thin dimension in the z-direction and being significantly wider in the y-direction, then the element 100 is substantially self-supporting in the y-direction, since it can flex easily in the z-direction but not in the y-direction.

Inorganic fibers 102, such as fibers of glass, glass-ceramic or ceramic, are disposed within the matrix 104. Individual fibers 102 may extend throughout the length of the film 100, although this is not a requirement. In the illustrated embodiment, the fibers 102 are lengthwise oriented parallel to the x-direction, although this need not be the case. The fibers 102 may be organized within the matrix 104 as single fibers or in many other arrangements, as described below.

The refractive indices in the x-, y-, and z-directions for the material forming the polymer matrix 104 are referred to herein as n₁ₓ, n_{1y} and n_{1z}. Where the polymer material is isotropic, the x-, y-, and z-refractive indices are all substantially matched. Where the matrix material is birefringent, at least one of the x-, y- and z-refractive indices is different from the others. In some cases, only one refractive index is different from the others, in which case the material is called uniaxial, and in others all three refractive indices are different, in which case the material is called biaxial. The material of the inorganic fibers 102 is typically isotropic. Accordingly, the refractive index of the material forming the fibers is given as n₂. The inorganic fibers 102 may also be birefringent.

In some embodiments, it may be desired that the polymer matrix 104 be isotropic, i.e. n₁ₓ≈n_{1y}≈n_{1z}≈n₁. To be considered isotropic, the differences among the refractive indices n₁ₓ, n_{1y} and n_{1z}, should be less than 0.05, preferably less than 0.02 and more preferably less than 0.01. Furthermore, in some embodiments it is desirable that the refractive indices of the matrix 104 and the fibers 102 be substantially matched. Thus, the refractive index difference between the matrix 104 and the fibers 102, the difference between n₁ and n₂ should be small, at least less than 0.02, preferably less than 0.01 and more preferably less than 0.002

In other embodiments, it may be desired that the polymer matrix be birefringent, in which case at least one of the matrix refractive indices is different from the refractive index of the fibers 102. For example, if the matrix is uniaxially birefringent such that n₁ₓ≈n_{1z}≠n_{1y}, then the values of n₁ₓ and n_{1z} may be closely matched to n₂. However, n_{1y} is different from n₂, with the result that light polarized in the y-direction is scattered by the film 100, but light that is polarized in the x-direction passes through the film substantially free of scatter. The amount of scattering experienced by the y-polarized light depends on several factors, including the magnitude of the refractive index difference n₂−n_{1y}, the size of the fibers 102 and the density of the fibers 102. Furthermore, the light may be forward scattered (diffuse transmission), backscattered (diffuse reflection), or a combination of both. The refractive index mismatch at the birefringent interface between the matrix 104 and the fibers 102 may be at least 0.05, and may be greater, for example 0.1, or 0.15 or may be 0.2.

While the exemplary embodiment just described is directed to index matching in the x-direction, with a relatively large index difference in the y-direction, other exemplary embodiments include index matching in the y-direction, with a relatively large index difference in the x-direction.

Matrix

Suitable materials for use in the polymer matrix include thermoplastic and thermosetting polymers that are transparent over the desired range of light wavelengths. In some embodiments, it may be particularly useful that the polymers be non-soluble in water, the polymers may be hydrophobic or may have a low tendency for water absorption. Further, suitable polymer materials may be amorphous or semi-crystalline, and may include homopolymer, copolymer or blends thereof. Example polymer materials include, but are not limited to, poly(carbonate) (PC); syndiotactic and isotactic poly(styrene) (PS); C1-C8 alkyl styrenes; alkyl, aromatic, and aliphatic ring-containing (meth)acrylates, including poly(methylmethacrylate) (PMMA) and PMMA copolymers; ethoxylated and propoxylated (meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; saturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends. The term (meth)acrylate is defined as being either the corresponding methacrylate or acrylate compounds. With the exception of syndiotactic PS, these polymers may be used in an optically isotropic form.

In some product applications, it is important that film products and components exhibit low levels of fugitive species (low molecular weight, unreacted, or unconverted molecules, dissolved water molecules, or reaction byproducts). Fugitive species can be absorbed from the end-use environment of the product or film, e.g. water molecules, can be present in the product or film from the initial product manufacturing, e.g. water, or can be produced as a result of a chemical reaction (for example a condensation polymerization reaction). An example of small molecule evolution from a condensation polymerization reaction is the liberation of water during the formation of polyamides from the reaction of diamines and diacids. Fugitive species can also include low molecular weight organic materials such as monomers, plasticizers, etc.

The fugitive species are generally lower molecular weight than the majority of the material comprising the rest of the functional product or film. Product use conditions might, for example, result in thermal stress that is differentially greater on one side of the product or film. In these cases, the fugitive species can migrate through the film or volatilize from one surface of the film or product causing concentration gradients, gross mechanical deformation, surface alteration and, sometimes, undesirable out-gassing. The out-gassing could lead to voids or bubbles in the product, film or matrix, or problems with adhesion to other films. Fugitive species can, potentially, also solvate, etch or undesirably affect other components in product applications.

Several of these polymers may become birefringent when oriented. In particular, PET, PEN, and copolymers thereof, and liquid crystal polymers, manifest relatively large values of birefringence when oriented. Polymers may be oriented using different methods, including extrusion and stretching. Stretching is a particularly useful method for orienting a polymer, because it permits a high degree of orientation and may be controlled by a number of easily controllable external parameters, such as temperature and stretch ratio.

The matrix 104 may be provided with various additives to provide desired properties to the optical body 100. For example, the additives may include one or more of the following: an anti-weathering agent, UV absorbers, a hindered amine light stabilizer, an antioxidant, a dispersant, a lubricant, an anti-static agent, a pigment or dye, a nucleating agent, a flame retardant and a blowing agent.

Some exemplary embodiments may use a polymer matrix material that is resistant to yellowing and clouding with age. For example, some materials such as aromatic urethanes become unstable when exposed long-term to UV light, and change color over time. It may be desired to avoid such materials when it is important to maintain the same color long term.

Other additives may be provided to the matrix 104 for altering the refractive index of the polymer or increasing the strength of the material. Such additives may include, for example, organic additives such as polymeric beads or particles and polymeric nanoparticles. In some embodiments, the matrix is formed using a specific ratio of two different monomers, where each monomer, a and b, is associated with a different final refractive index when polymerized, for example nₐ and n_{b}, where the subscripts a and b refer to monomers a and b respectively. Where nₐ is less than n_{b}, and the weight fraction of monomer b in the mixture is r, then the value of the refractive index of the matrix, nₘ is given by: nₘ=nₐ+r(n_{b}−nₐ). In other embodiments, linear combinations of three or more different monomers may be used to produce a desired value of refractive index. The examples provided below illustrate the ability to tune to the refractive index using mixture of three four or even five monomers.

In other embodiments, inorganic additives may be added to the matrix to adjust the refractive index of the matrix, or to increase the strength and/or stiffness of the material. For example, the inorganic material may be glass, ceramic, glass-ceramic or a metal-oxide. Any suitable type of glass, ceramic or glass-ceramic, discussed below with respect to the inorganic fibers, may be used. Suitable types of metal oxides include, for example, titania, alumina, tin oxides, antimony oxides, zirconia, silica, mixtures thereof or mixed oxides thereof. These inorganic materials are preferably provided as nanoparticles, for example milled, powdered, bead, flake or particulate in form, and distributed within the matrix. The size of the particles is preferably lower than about 200 nm, and may be less then 100 nm or even 50 nm to reduce scattering of the light passing through the film.

The surfaces of these inorganic additives may be provided with a coupling agent for binding the fiber to the polymer. For example, a silane coupling agent may be used with an inorganic additive to bind the inorganic additive to the polymer. Although inorganic nanoparticles lacking polymerizable surface modification can be employed, the inorganic nanoparticles may be surface modified such that the nanoparticles are polymerizable with the organic component of the matrix. For example, a reactive group may be attached to the other end of the coupling agent. The group can chemically react, for example, through chemical polymerization via a double bond with the reacting polymer matrix.

Fiber Reinforcement Any suitable type of inorganic material may be used for the fiber 102. The fiber 102 may be formed of a glass that is substantially transparent to the light passing through the film. Examples of suitable glasses include glasses often used in fiberglass composites such as E, C, A, S, R, and D glasses. Higher quality glass fibers may also be used, including, for example, fibers of fused silica and BK7 glass. Suitable higher quality glasses are available from several suppliers, such as Schott North America Inc., Elmsford, N.Y. It may be desirable to use fibers made of these higher quality glasses because they are purer and so have a more uniform refractive index and have fewer inclusions, which leads to less scattering and increased transmission. Also, the mechanical properties of the fibers are more likely to be uniform. Higher quality glass fibers are less likely to absorb moisture, and thus the film becomes more stable for long term use. Furthermore, it may be desirable to use a low alkali glass, since alkali content in glass increases the absorption of water.

Another type of inorganic material that may be used for the fiber 102 is a glass-ceramic material. Glass-ceramic materials generally comprise 95% -98% vol. of very small crystals, with a size smaller than 1 micron. Some glass-ceramic materials have a crystal size as small as 50 nm, making them effectively transparent at visible wavelengths, since the crystal size is so much smaller than the wavelength of visible light that virtually no scattering takes place. These glass-ceramics can also have very little, or no, effective difference between the refractive index of the glassy and crystalline regions, making them visually transparent. In addition to the transparency, glass-ceramic materials can have a rupture strength exceeding that of glass, and are known to have coefficients of thermal expansion of zero or that are even negative in value. Glass-ceramics of interest have compositions including, but not limited to, Li₂O—Al₂O₃—SiO₂, CaO—Al₂O₃—SiO₂, Li₂O—MgO—ZnO—Al₂O₃—SiO₂, Al₂O₃—SiO₂, and ZnO—Al₂O₃—ZrO₂—SiO₂, Li₂O-Al₂O₃—SiO₂, and MgO—Al₂O₃—SiO₂.

Some ceramics also have crystal sizes that are sufficiently small that they can appear transparent if they are embedded in a matrix polymer with an index of refraction appropriately matched. The Nextel™ Ceramic fibers, available from 3M Company, St. Paul, Minn., are examples of this type of material, and are available as thread, yarn and woven mats. Suitable ceramic or glass-ceramic materials are described further in Chemistry of Glasses, 2^{nd} Edition (A. Paul, Chapman and Hall, 1990) and Introduction to Ceramics, 2^{nd} Edition (W. D. Kingery, John Wiley and Sons, 1976), the relevant portions of both of which are incorporated herein by reference.

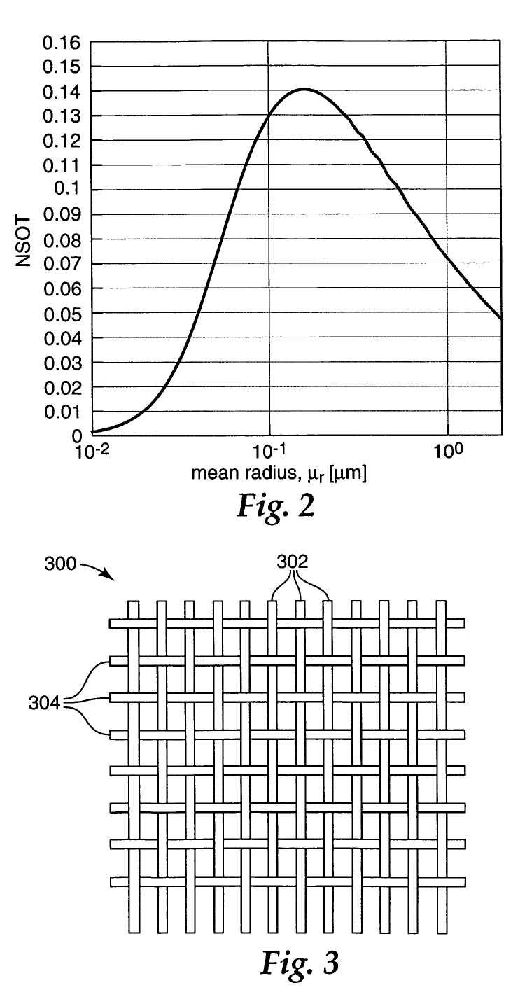

The size of the fibers 102 can have a significant effect on scattering the light that passes through the film 100, if the fiber refractive index is not well matched to the refractive index of the matrix. A plot of scattering effectiveness, the normalized, scaled optical thickness (NSOT), is shown as a function of mean radius of fiber, in FIG. 2. The NSOT is given by the following expression:
NSOT=T(1−g)/(tf)
where T is the optical thickness and equals tk, where k is the extinction cross-section per unit volume (the reciprocal of the mean free path for extinction), t is the thickness of the film 100 diffuser, f is the volume fraction of fibers and g is the asymmetry parameter. The value of g is +1 for pure forward-scattering, −1 for pure back-scattering and zero for equally forward and backward scattering. The calculation used to produce the plot assumed that the vacuum wavelength of the incident light was 550 nm.

As can be seen, the scattering effectiveness peaks at a fiber radius of about 150 nm, and has a value of about half the maximum over a radius range of about 50 nm-1000 nm. Therefore, in some embodiments it may be desired that the radius of the fibers 102 lie outside this range. It is less practical to use single fibers 102 having a radius significantly smaller than 150 nm, since single fibers of such a small size are difficult to make and to handle. Therefore, it is easier to use fibers 102 have a radius of at least 2 μm and preferably more than 3 μm for visible light.

In some exemplary embodiments, it may be desirable not to have perfect refractive index matching between the matrix and the fibers, so that at least some of the light is diffused by the fibers. In such embodiments, either or both of the matrix and fibers may be birefringent, or both the matrix and the fibers may be isotropic. Depending on the size of the fibers, the diffusion arises from scattering or from simple refraction. Diffusion by a fiber is non-isotropic: light may be diffused in a direction lateral to the axis of the fiber, but is not diffused in an axial direction relative to the fiber. Accordingly, the nature of the diffusion is dependent on the orientation of the fibers within the matrix. If the fibers are arranged, for example, parallel to the x- and y-axes, then the light is diffused in directions parallel to the x- and y-axes.

In addition, the matrix may be loaded with diffusing particles that isotropically scatter the light. Diffusing particles are particles of a different refractive index than the matrix, often a higher refractive index, having a diameter up to about 10 μm. The diffusing particles may be, for example, metal oxides such as were described above for use as nanoparticles for tuning the refractive index of the matrix. Other suitable types of diffusing particles include polymeric particles, such as polystyrene or polysiloxane particles, or a combination thereof. The diffusing particles may be used alone to diffuse the light, or may be used along with non-index-matched fibers to diffuse the light.

Some exemplary arrangements of fibers within the matrix include yarns, tows of fibers or yarns arranged in one direction within the polymer matrix, a fiber weave, a non-woven, chopped fiber, a chopped fiber mat (with random or ordered formats), or combinations of these formats. The chopped fiber mat or nonwoven may be stretched, stressed, or oriented to provide some alignment of the fibers within the nonwoven or chopped fiber mat, rather than having a random arrangement of fibers. Furthermore, the matrix may contain multiple layers of fibers: for example the matrix may include more layers of fibers in different tows, weaves or the like.

Organic fibers may also be embedded within the matrix 104 along with the inorganic fibers 102. Some suitable organic fibers that may be included in the matrix include polymeric fibers, for example fibers formed of one or more of the polymeric materials listed above. Polymeric fibers may be formed of the same material as the matrix 104, or may be formed of a different polymeric material. Other suitable organic fibers may be formed of natural materials, for example cotton, silk or hemp.

Some organic materials, such as polymers, may be optically isotropic or may be optically birefringent. Birefringent polymer fibers may be used to introduce polarization-dependent properties into the film, for example as is described in U.S. patent application Ser. Nos. 11/068,157 and 11/068158, both of which were filed on Feb. 28, 2005 and are incorporated by reference.

In some embodiments, the organic fibers may form part of a yarn, tow, weave and the like that contains only polymer fibers, e.g. a polymer fiber weave. In other embodiments, the organic fibers may form part of a yarn, tow, weave and the like that comprises both organic and inorganic fibers. For example, a yarn or a weave may include both inorganic and polymeric fibers. An embodiment of a fiber weave 300 is schematically illustrated in FIG. 3. The weave is formed by warp fibers 302 and weft fibers 304. The warp fibers 302 may be inorganic or organic fibers, and the weft fibers 304 may also be organic or inorganic fibers. Furthermore, the warp fibers 302 and the weft fibers 304 may each include both organic and inorganic fibers. The weave 300 may be a weave of individual fibers, tows, or may be a weave of yarn, or any combination of these.

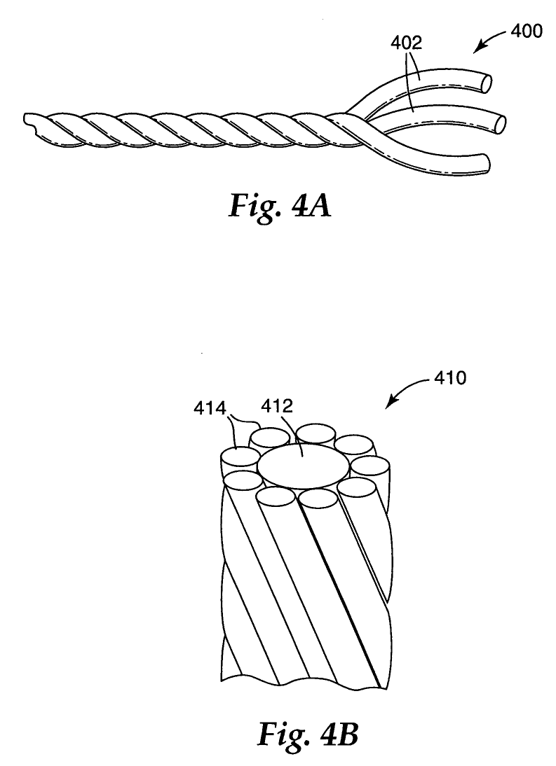

A yarn includes a number of fibers twisted together. The fibers may run the entire length of the yarn, or the yarn may include staple fiber, where the lengths of individual fibers are shorter than the entire length of the yarn. Any suitable type of yarn may be used, including a conventional twisted yarn 400, for example as schematically illustrated in FIG. 4A, formed of fibers 402 twisted about each other. The fibers 402 may be inorganic, organic, or both.

Another embodiment of yarn 410, schematically illustrated in FIG. 4B, is characterized by a number of polymer fibers 414 wrapped around a central fiber 412. The central fiber 412 may be an inorganic fiber or an organic fiber. A yarn, such as yarn 410, which includes both inorganic and polymer fibers, may be used to provide particular optical properties associated with the polymer fibers 414 while also providing the strength of the inorganic central fiber 412. For example, a polymer fiber may be isotropic or may be birefringent. The polymer fibers may be made to be birefringent using any suitable method including orienting the polymer material by stretching the fibers under proper processing conditions. The birefringent polymer fibers introduce polarization-dependent properties to the film. For example, the film may have substantially diffuse transmission or diffuse reflection for one polarization state and substantially specular transmission for the orthogonal polarization state.

The polymer fibers used in a film are typically below about 250 μm in diameter, and may have a diameter down to about 5 μm or less. Handling of small polymer fibers individually may be difficult. Using polymeric fibers in a mixed yarn, containing both polymer and inorganic fibers, however, provides for easier handling of the polymeric fibers since the yarn is less prone to being damaged by handling.

Film

Optical films that are reinforced with inorganic fibers have a thickness that is at least as thick as the inorganic fibers. Typically, the optical films may have a thickness up to about 5 mm, although the film's thickness may be greater than this value in some embodiments. In other embodiments, the thickness is less than 250 μm and may even be less than 25 μm. In many applications, the film is substantially transparent, so that less than 10%, preferably less than 5% and more preferably less than 1% of the incident light is absorbed in the film. It should be noted that transparence is not the same as transmission, since transparence is concerned only with absorption, and is not related to how much light is transmitted instead of being reflected.

In some embodiments, the matrix is optically isotropic. In other embodiments, the matrix may be optically birefringent. One common approach to producing a birefringent matrix is to stretch the matrix under controlled temperature conditions, for example by 2-10 times or more. Stretching may take place either along the web or across the web. A matrix containing inorganic fibers may be stretched, for example, when the fibers are chopped. In another approach, where the matrix contains fibers in the form of a tow, the matrix may be stretched in a direction across the tow.

The above-described method includes the incorporation of pre-existing glass, ceramic or glass-ceramic fibers or particles into a polymeric matrix to enhance the mechanical properties of the resulting article. Another approach is to create dimensionally stable, stiff, thermally processable composite materials through the co-processing of glasses and polymers. The glasses have a relatively low melting point and are suitable for co-processing with polymers that have a relatively high melting point. Methods to create such materials are described in “Glass-Polymer Melt Blends” (Quinn C. J., Frayer P., and Beall G.) in the Polymeric Materials Encyclopedia (CRC Press, Inc., 1996) p. 2766. Phosphate (P₂O₅) glasses can have viscous flow at temperatures well below 400° C. and have sufficiently low viscosities to co-form with polymers. Advantages of the co-extrusion method include good wetting of the glass by the polymer melt, and good interfacial bonding between the glass and the polymer without the use of conventional coupling agents. A variety of glass structures within the composite have been shown including small beads, fine diameter fibers, ribbons and plates.

The use of co-processable glasses may provide the opportunity for matching refractive index with the polymer matrix and also for inducing birefringence in the matrix polymer after the incorporation of the reinforcement glass fiber into the composite. The co-processable glass reinforcements provide an opportunity to do additional thermal and mechanical processing (potentially including the inducement of birefringence) after the composite has already been formed.

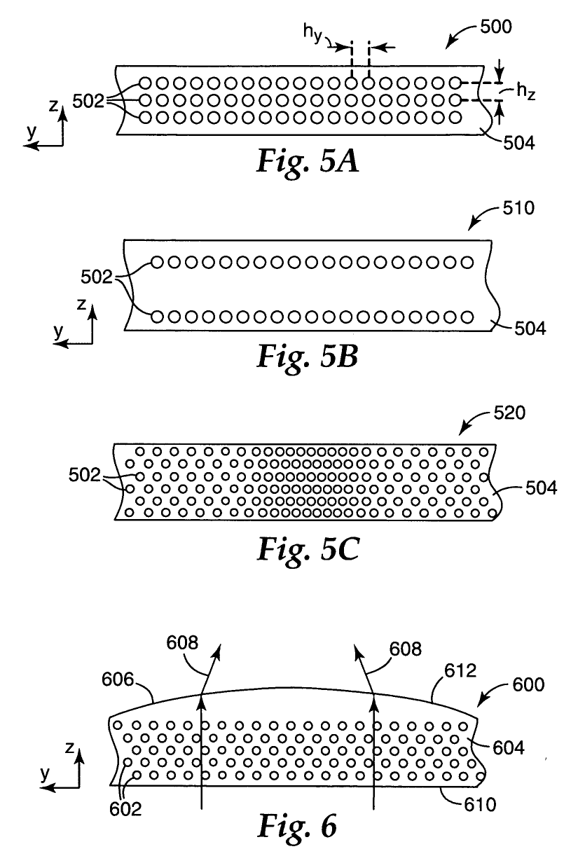

The positions of the fibers within the film may be random, for example as shown in FIG. 1B, or may be regular. Furthermore, the spacing between adjacent fibers may vary for different positions within the film. For example, the film 500, schematically shown in cross-section in FIG. 5A, has fibers 502 positioned regularly within the matrix 504 in a rectangular grid pattern. The inter-fiber spacings in the y-direction and in the z-direction are h_{y} and h_{z} respectively. The values of h_{y} and h_{z} may be the same, or they may be different. In addition, the values of h_{y} and h_{z} need not be uniform throughout the width or thickness of the film.

The positions of the fibers 502 within the matrix 504 may be selected to provide increased stiffness to the film. For example, in the exemplary embodiment schematically illustrated in FIG. 5B, the fibers 502 are positioned in two rows close to the respective surfaces of the film 510. In any cross-section of material, the maximum bending stress occurs at the outer surfaces. Therefore, locating the fibers, which generally have greater tensile strength and/or Young's modulus, than the matrix material, near to the surface leads to significant increases in the stiffness of the film or article. This configuration may provide increased stiffness over a film configuration where the two rows of fibers 502 are positioned close to the center of the film 510.

Other types of grid patterns may be used where the fibers 502 are positioned regularly within the film. For example, the fibers 502 may be arranged in a hexagonal pattern, as is schematically illustrated in FIG. 5C for film 520. In addition, the in-plane spacing, in the y-direction, is not constant across the film, and the density of fibers 502 in one area may be higher than in another. A configuration like that shown in FIG. 5C may be useful in applications where it is desired that diffusion of the illumination light by the fibers 502 be spatially non-uniform across the film 520. This may be used, for example, to provide non-uniform diffusion in a display so as to hide individual light sources.

The film may have flat surfaces, for example the flat surfaces parallel to the x-y plane as shown in FIGS. 1A and 1B. The film may also include one or more surfaces that are structured to provide desired optical effects for light incident on the film. For example, in one exemplary embodiment schematically, illustrated in FIG. 6, the film 600 is formed with fibers 602 embedded within the matrix 604, and has an output surface 606 that is curved. The curved output surface 606 provides optical power, focusing or defocusing, to light transmitted through the surface 606. In the illustrated embodiment, rays 608 represent examples of light rays that are focused by the curved refracting surface 606. In other exemplary embodiments, the input surface 610 of the element 600, may be curved, or there may be other surface structure. Furthermore, there may be surface structure on the output surface 612 through which transmitted light exits the film. An example of surface structure includes constructions such as a Fresnel lens structure and a lens array. These structures are considered to provide optical power to light passing through the film 600.

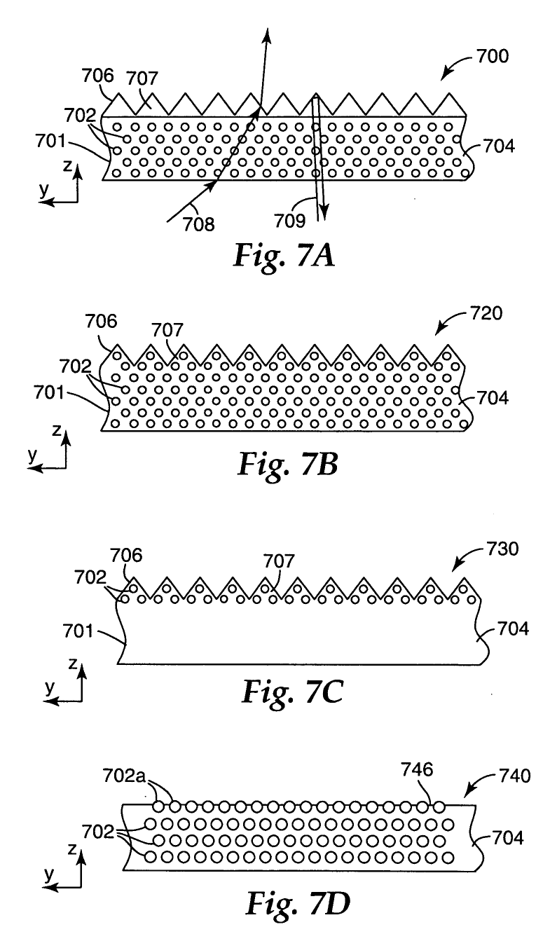

The structured surface of either, or both, the input and output surfaces may also include rectilinear regions in addition to, or instead of, curved regions. For example, in another exemplary embodiment, schematically illustrated in FIG. 7A, the film 700, formed with fibers 702 embedded within the matrix 704, may be provided with a prismatically structured output surface 706, referred to as a brightness enhancing surface. A brightness enhancing surface is commonly used, for example in backlit liquid crystal displays, to reduce the cone angle of the light illuminating the display panel, and thus increase the on-axis brightness for the viewer. The figure shows an example of two light rays 708 and 709 that are incident on the film 700. Light ray 708 is obliquely incident on the film 700 and is diverted towards the z-axis by the structured surface 706. Light ray 709 is close to, or is, perpendicularly incident on the film 700 and is retroreflected by the brightness enhancing surface 706. The brightness enhancing surface 706 may be arranged so that the prism structures 707 are parallel to the fibers 702, which is also parallel to the x-axis, as illustrated. In other embodiments, the prism structures 707 may lie at some other angle relative to the direction of the fibers 702. For example, the prism structures 707 ribs may lie parallel to the y-axis, perpendicular to the fibers 702, or at some angle between the x-axis and the y-axis. The prism structures 707 may be formed of the same material as the matrix 704, or may be formed of a different material.

Structured surfaces may be formed on the matrix using any suitable method. For example, the matrix may be cured, or otherwise hardened, while its surface is in contact with the surface of a tool, such as a microreplication tool, whose tool surface produces the desired shape on the surface of the polymer matrix.

The fibers 702 may be present across different regions of the film. In the exemplary embodiment schematically illustrated in FIG. 7A, the fibers 702 are not located in the prism structure 707 formed by the structured surface 706, but are located only in the main body 701 of the film 700. In other embodiments, the fibers 702 may be distributed differently. For example, in the film 720, schematically illustrated in FIG. 7B, the fibers 702 are located within both the main body 701 of the film 720, and also in the structure 707 formed by the structured surface 706. In another example, schematically illustrated in FIG. 7C, the fibers 702 are located only in the structure 707 of the film 730 and not in the main body 701 of the film 730.

Other types of structured surfaces may be used in addition to those discussed above. For example, a structured surface may be a diffusing surface.

Another exemplary embodiment of the invention is schematically illustrated in FIG. 7D, in which the film 740 has fibers 702 embedded in a matrix 704. In this particular embodiment, some of the fibers 702a are not completely embedded within the matrix 704, but penetrate the surface 746 of the matrix 704. This arrangement, in which there is an optical interface between the fibers 702a and the air, or other medium, outside the film 740, may result in optically diffusing the light that passes through the fibers 702a.

Inorganic fibers are relatively stiff compared to many polymer materials, having a higher tensile strength and Young's modulus, and so polymer films reinforced with inorganic fibers are typically stiffer than polymer films that are not fiber-reinforced. Consequently, fiber-reinforced films become more suitable for use in larger displays. Furthermore, the presence of the inorganic fibers provides greater mechanical stability and lowers the article's coefficient of thermal expansion, thus reducing the possibility that the optical film warps when its temperature increases when operated in the display.

One example of a high tensile strength application is where a fiber-reinforced film is used as a substitute for glass sheets in a liquid crystal display (LCD) panel. Conventionally, the LCD panel includes two glass cover sheets separated by a thin layer (up to a few tens of microns) of liquid crystal. The inner surfaces of the cover sheets are provided with a patterned conductive coating to act as electrodes for the various pixels of the display. Metallic traces on the glass provide electrical connection to the patterned conductive layer. As the size of the display panel increases, glass cover sheets become increasingly heavy and expensive, and so they may be substituted by fiber-reinforced cover sheets. Such cover sheets, however, have to withstand high processing temperatures, for example in excess of 150° C.-180° C. The patterned conductive coating, the metallic traces that connect to the conductive coating and the polymeric cover sheet have different coefficients of thermal expansion (CTEs), which can lead to delamination of the conductive layer, or rupture of the metallic traces that connect to the patterned conductive layer, when the cover sheet experiences large swings in temperature. Glass fiber reinforcement has been proposed as an approach for reducing the expansion of the polymeric sheet, since the CTE of the glass fibers is less than that of the polymer material. This use of glass fibers in polymer sheets typically relies on the tensile strength of the fibers and the presence of good mechanical and chemical coupling between the fibers and the polymer matrix so that there is little slippage between the two. Accordingly, it is common to use a chemical binder on the surface of the fiber, for example a silane coupling agent to bind the polymer matrix to the fiber. Also, the fiber density (the number of fibers present per unit distance measured across the film, perpendicular to the fibers) is relatively high, in order to provide the desired tensile strength and low CTE.

In contrast, the density of fibers in some of the embodiments of fiber-reinforced optical films described here can be relatively low, enough to provide sufficient stiffness for the particular application, but without the need for the high tensile strength in the LCD application discussed in the previous paragraph. As a result, fewer fibers need be used, which reduces the haze produced by the film (the fraction of the transmitted light that is diffusely transmitted) when there is a slight mismatch between the refractive indices of the polymer and the fiber material. Furthermore, in some exemplary embodiments, the binding agent, the agent that binds the fiber to the matrix, may be omitted, since the requirement for strong binding between the fiber and the matrix is reduced when stiffness, not strength, is the main concern. The CTE of the film containing the inorganic fibers is still less than that of the polymer matrix alone, however, even when the coupling agent is omitted. In addition, omission of the coupling agent also reduces any problems with index matching that may arise due to the coupling agent.

The alignment and the cross-sectional arrangement of the fibers within the film may lead to anisotropic mechanical and optical properties. For example, where the inorganic fibers are aligned along only one direction, say the x-direction, the film is more resistant to bending with a radius parallel to the x-z plane, i.e. bending the fibers so that they are no longer parallel to the x-axis. There is less resistance, however, to bending the film with a radius parallel to the y-z plane, and so the film may be less rigid in one direction than the other. Where the inorganic fibers are placed both parallel to both the x- and y-axes, the film may become more isotropically rigid, although the rigidity along a particular direction depends on the number of fibers lying in that direction. If the number of fibers lying parallel to the x-direction is not the same as the number of fibers lying parallel to the y-direction, then the rigidity in the x-direction may be different from the rigidity in the y-direction. If the rigidity in the x-direction and the y-direction is the same, then the rigidity may be termed “pseudo-isotropic”. Furthermore, the rigidity for directions non-parallel to the x- and y-axes may not be the same as rigidity parallel to one of these axes. The inorganic fibers may, of course be placed at any desired orientation within the film, and need not only be aligned along either or both the x- and y-axes. Some fibers, for example, may be aligned in a direction non-parallel to both the x- and y-axes.

In addition to stiffness, other mechanical properties of the film that may become anisotropic include tensile strength, thermal expansion coefficient and tear strength. Also, optical properties, such as scattering, may become anisotropic if the fibers that scatter the light, either inorganic, polymeric or both, are arranged along only one direction. These film properties, of course, may also be pseudo-isotropic if the fibers that contribute to these properties are crossed, or may become more isotropic if the fibers are arranged in a multiplicity of different directions.

The components of the film, including the matrix, the fibers and any additives provided to the film, may affect the optical properties of the film in a selected manner. For example, the various component parts of the film may all be selected to be transparent to the incident light. In addition, additives such as dyes or pigments may be provided to absorb light, or the polymer may contain molecular components that absorb light. In some exemplary embodiments, the dyes, pigments or molecular components may be aligned, for example by stretching a base film layer containing the dyes, pigments or molecular components, resulting in preferred absorption of light in one polarization state over the orthogonal polarization state. The optical film may be made by applying one or more layers of the fibers over the base film layer. The dyes, pigments or molecular components if present, are selected to absorb light in specific wavelength ranges. In other embodiments, the additives may be disposed within the matrix itself.

Some additives, such as dyes, may convert the frequency of the incident light, for example through fluorescence. In one example, the matrix may be impregnated with a dye that absorbs UV light and emits visible light.

The film may have a color-selective scattering capability. This capability may arise, for example, by selecting the wavelength, λ₀, at which the fiber refractive index and the matrix refractive index are matched. Where the dispersion of the fiber and matrix materials is different, the refractive index difference increases for wavelengths further away from λ₀. Where little scattering, or neutral scattering is desired, λ₀ is typically set close to the center of the wavelength range of the light passing through the film. Thus, if visible light having a range of about 400 nm-700 nm is passing through the film, then λ₀ may be set somewhere in the range 500 nm-600 nm. If, however, it is desired that the film scatter light at one wavelength more than others, then λ₀ may be shifted accordingly. For example, if it is desired that blue light be scattered more than red or green light, then λ₀ may be set at longer wavelengths, for example in the range 600 nm-700 nm, so that the refractive index mismatch for blue light in the range 400 nm-500 nm is higher and the scattering is increased.

The refractive indices of different materials within the optical film change with temperature. Since the optical properties of the fiber-reinforced film depend, at least in part, on the magnitude of the refractive index mismatch between the matrix and the fiber material, it is possible for the optical properties of the film to change with temperature if the refractive index mismatch between the materials is not kept within a desired range during a change in temperature. Consider an example where the matrix material and inorganic fiber have matched refractive indices at room temperature (20° C.). If, however, the value of dn/dT, the rate at which the refractive index, n, changes with temperature, T, is different for the two materials, then the refractive indices may become unmatched at an elevated operating temperature, for example 50°. In some exemplary embodiments, therefore, the materials of the matrix and the glass fiber may be selected to reduce the difference between the values of dn/dT for the polymer and inorganic materials, for a specific operating temperature range.

In some other embodiments, it may be desired to increase the difference in the value of dn/dT for the two materials, so that the film becomes more highly temperature sensitive. For example, it may be desirable in some exemplary architectural applications for the film to have a temperature sensitive transmission. In illustration, it may be desired that windows in a building or greenhouse have a temperature dependence that reduces the amount of light passing through the window if the temperature increases above a certain temperature.

Dispersion in the polymer matrix and the inorganic fiber material results in the refractive index being different in each material for different wavelengths: the refractive index is higher for shorter wavelengths. Thus, an exact refractive index match may be made between the matrix and the inorganic fiber material for one wavelength but, where the dispersion (dn/dλ, λ being the vacuum wavelength) of the two materials is not the same, the difference between the two refractive indices will increase for wavelengths further away from the matched wavelength. Therefore, it may be desired in some embodiments to set the wavelength where the refractive indices match, λₘ, close to the center of the wavelength range of interest. Thus, for an optical film that is used in a display that covers the wavelength range 400 nm-700 nm, the value of λₘ may in the range of 500 nm-600 nm. In addition, some combinations of polymer and inorganic materials have values of dn/dλ are that are closer than other combinations.

Processing

Several different approaches may be used for manufacturing a fiber-reinforced optical film. Some approaches include batch processing while others include continuous processing. In one exemplary embodiment, discussed above, the inorganic material has a lower melting temperature than the polymer matrix, and the two materials are co-extruded. In this approach, the positions of the inorganic fibers, droplets or ribbons within the matrix are determined by phase separation that occurs in the polymer/inorganic melt.

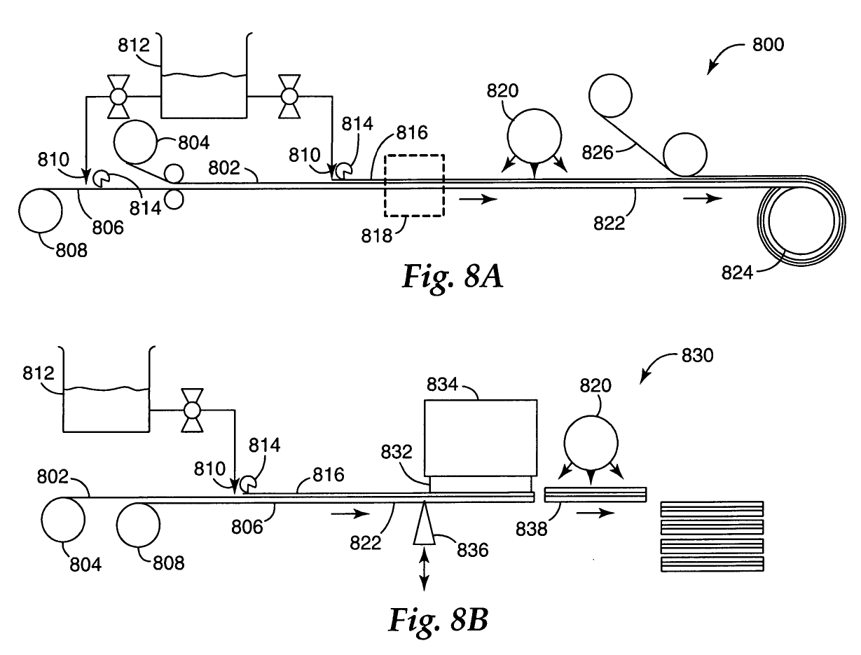

Another exemplary embodiment of a system 800 suitable for continuous processing is schematically illustrated in FIG. 8A. An inorganic fiber layer 802, for example a tow, a weave, nonwoven or the like, may be pulled off a roll 804 and placed on a backing layer 806 that is pulled off another roll 808. A resin 810 is applied over the inorganic fiber layer 802 from a reservoir 812, and a coater 814 forms a layer 816 of the resin. In some embodiments, the resin 810 may also be applied over the backing layer 806 before the inorganic fiber layer 802 is applied. The resin 810 becomes impregnated into the fiber layer 802. The resin 810 may be a thermoplastic polymer or a thermosetting polymer. The coater 814 may be any suitable type of coater, for example a knife edge coater, comma coater (illustrated), bar coater, die coater, spray coater, curtain coater, high pressure injection, or the like. Among other considerations, the viscosity of the resin at the application conditions determines the appropriate coating method or methods. The coating method and resin viscosity also affect the rate and extent to which air bubbles are eliminated from the reinforcement during the step where the reinforcement is impregnated with the matrix resin.

Where it is desired that the finished film have low scatter, it is important at this stage to ensure that the resin completely fills the spaces between the fibers: any voids or bubbles left in the resin may act as scattering centers. Different approaches may be used, individually or in combination, to reduce the occurrence of bubbles. For example, the film may be mechanically vibrated to encourage the dissemination of the resin 810 throughout the fiber layer 802. The mechanical vibration may be applied using, for example, an ultrasonic source. In addition, the film may be subject to a vacuum that extracts the bubbles from the resin 810. This may be performed at the same time as coating or afterwards, for example in an optional de-aeration unit 818.

The resin 810 in the film may then be solidified at a solidification station 820. Solidification includes curing, cooling, cross-linking and any other process that results in the polymer matrix reaching a solid state. In some embodiments, different forms of energy may be applied to the resin 810 including, but not limited to, heat and pressure, UV radiation, electron beam and the like, in order to cure the resin 810. In other embodiments, the resin 810 may be solidified by cooling or by cross-linking. In some embodiments, the solidified film 822 is sufficiently supple as to be collected and stored on a take-up roll 824. In other embodiments, the solidified film 822 may be too rigid for rolling, in which case it is stored some other way, for example the film 822 may be cut into sheets for storage.

The backing layer 806 may act as a carrier or premask-type substrate for the film, or may provide some desired optical characteristics. For example, the backing layer 806 may be optically isotropic or birefringent, or may be loaded with an absorbing dye or pigment, or may intrinsically contain absorbing species. The backing layer may provide physical support and limit the ingress of gasses and/or water vapor prior to solidification. In other embodiments, the backing layer 806 may be a peelable protective layer used for protecting the film while being stored and transported.

Other layers may be added to the film. For example, an upper protective layer 826 may be added to the film. Furthermore, additional fiber layers and resin layers may be added to build up a multilayered, fiber-reinforced film. Additional fiber and resin layers may be added before the first resin layer 816 is solidified or after the first resin layer 816 is solidified. In some embodiments, the first resin layer 816 may be partially solidified before the application of another fiber layer and resin layer.

In some embodiments, one or more of the sheets being applied to the film may be applied in a direction that is not parallel to the web. One example of such a film is a fiber tow that is applied so that the fibers lie across the web. In such cases, a cross-web sheet 832 may be applied over the film 822 using a sheet feeder 834, as is schematically illustrated for the system 830, shown in FIG. 8B. A cutting tool 836 may be used to cut the film 822 into sheets 838. The sheets 838 may be solidified at the solidification stage 820 before being stacked for storage.

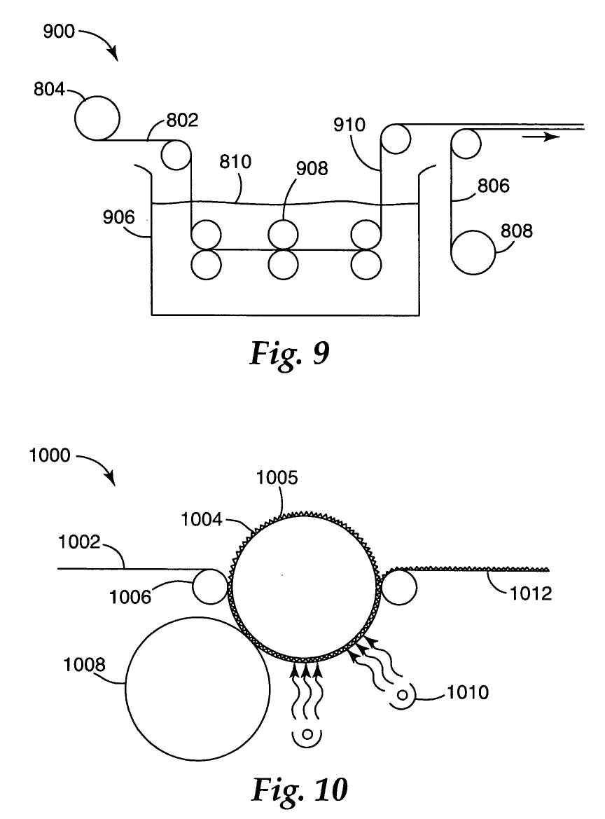

In some embodiments, the fiber layer 802 may be impregnated with resin 810 before being applied to the backing layer 806. Pre-impregnated fiber is referred to as “pre-preg”. One exemplary embodiment of a system 900 that may be used to prepare pre-preg is schematically illustrated in FIG. 9. The fiber layer 802 is extracted from the roll 804 and passed into a bath 906 containing the resin 810. The fiber layer 802 may pass through a number of rollers 908 to encourage the resin 810 to impregnate the spaces between the fibers of the layer 802. The resulting pre-preg 910 may then be extracted from the bath and applied to the backing layer 806 as described above. The application of a vacuum and/or ultrasonic energy may be used to further remove bubbles from the resin 810.

The fiber-reinforced film may be molded or shaped prior to solidification, or while being solidified. For example, the film may be molded to provide a structured surface, exemplary embodiments of which are illustrated in FIGS. 6 and 7A-7D. One embodiment of a system 1000 used to mold the film is shown schematically in FIG. 10. The film 1002 is guided to a molding roll 1004 by a guiding roll 1006 and may be pressed against the molding roll 1004 by an optional pressure roll 1008. The molding roll 1004 has a shaped surface 1005 that is impressed into the film 1002. The spacing between the molding roll 1004 and the pressure roll 1008 may be adjusted to a set distance that controls the depth of penetration of the shaped surface 1005 into the film 1002.

In some embodiments, the film 1002 may be solidified, or at least partially solidified, while still in contact with the molding roll 1004. In the case of a curable polymer, the matrix may be cured, for example, by irradiation with UV light or heat from an energy source 1010. In other embodiments, the molding roll 1004 is operated at an elevated temperature: the film 1002 is conductively heated since it is in intimate contact with the heated roll 1004, and is cured through heating. In other exemplary embodiments, the matrix may solidify through cooling, for example as with a thermoplastic polymer. In such a case, the roll 1004 may be maintained at a relatively low temperature so that the film or resin 1002 is cooled when in contact with the roll 1004.

The molded film 1012 may be stored on another roll or cut into sheets for storage. Optionally, the molded film 1012 may be further processed, for example through the addition of one or more layers.

Thermoplastic-based composites may be produced by injection molding. In one particular embodiment of that process, pellets containing 1-3 mm-long fibers are uniformly dispersed in the feedstock resin and are supplied to the injection molding machine. The molten polymer/fiber mixture is injected into a cavity of a split mold and allowed to solidify or cure, and the finished composite is removed from the mold. Three common thermoplastic resin matrix polymers for composite-making are polypropylene, nylon, and polycarbonate. Injection molding of thermoplastic/fiber mixtures to make composites is described in “An introduction to Composite Materials” by D. Hull, Cambridge University Press, 1990.

Pultrusion is another process for creating composites, especially those based on thermosetting matrix resins. In the pultrusion process, the fiber reinforcement is impregnated with the liquid matrix resin and is then drawn through a heated die which reduces excess resin, determines the cross-section shape of the finished composite and induces cure of the resin matrix. Other process variations are also practiced, such as resin injection into the reinforcement directly at the pultrusion die, rather than using a resin bath for impregnation prior to the heated die. Pultrusion processes are further described in “FRP Technology Fiber Reinforced Resin Systems”, by R. G. Weatherhead, Applied Science Publishers, 1980.

Select embodiments of this invention are described below. These examples are not meant to be limiting, only illustrative of some of the aspects of the invention. Table I contains a summary of relevant information of the different inorganic fiber samples used in Examples 1-15.

TABLE I
Summary of various fiber materials used in the Examples

| Mate- | | | | | |
|---|---|---|---|---|---|
| rial | | Style | Yarn | Weight | Refractive |
| ID | Manufacturer | Number | Description | (g m⁻²) | Index |
| A | BGF Industries, | 106 | ECD 900 | 24.5 | 1.548 |
| | Inc. | | 1/0 | | |
| B | Hexcel | 106 | ECD 900 | 24.4 | 1.549 |
| | Reinforcements | | 1/0 | | |
| C | Hexcel | 6060 | ECDE 600 | 39.9 | 1.552 |
| | Reinforcements | | 1/0 | | |
| D | Hexcel | 1620 | ECG 150 | 53.6 | 1.552 |
| | Reinforcements | | 1/0 | | |
| E | Hexcel | 1610 | ECG 150 | 77.0 | 1.554 |
| | Reinforcements | | 1/0 | | |
| F | 3M Company | Nextel | 2″ tape | | 1.568 |
| | | 312 | | | |

Materials A-E are woven fiberglass and material F is a woven ceramic fiber. The yarn description and weights were obtained from the manufacturer's literature. BGF Industries, Inc., is located in Greensboro, N.C., Hexcel Reinforcements Corp. is located in Anderson, S.C., and 3M Company is located in St. Paul, Minn. Each of the fiber materials was received from the vendor with sizing covering the fibers. Sizing is a layer on a fiber, often formed from starches, lubricants or a water-soluble polymer such as polyvinyl alcohol, that is used to facilitate processing or weaving of the fiber. In the examples described below, the sizing was left on the fibers before embedding the fibers in the polymer matrix. Consequently, the fibers were included in the composite samples without a coupling agent to couple between the fiber and the polymer matrix.

The refractive index (RI) of the fiber samples listed in Table I were measured with Transmitted Single Polarized Light (TSP) with a 20×/0.50 objective, and Transmitted Phase Contrast Zernike (PCZ) with a 20×/0.50 objective. The fiber samples were prepared for refractive index measurement by cutting portions of the fibers using a razor blade. The fibers were mounted in various RI oils on glass slides and covered with a glass coverslip. The samples were analyzed using the Zeiss Axioplan (Carl Zeiss, Germany).

Calibration of the RI oils was performed on an ABBE-3L Refractometer, manufactured by Milton Roy Inc., Rochester, N.Y., and values were adjusted accordingly. The Becke Line Method accompanied with phase contrast was used to determine the RI of the samples. The nominal RI results for the values of n_{D}, the refractive index at the wavelength of the sodium D-line, 589 nm, had an accuracy of ±0.002 for each sample.

Summary information for various resins used in the examples is provided in Table II.

TABLE II
Resin Components

| Component | | Resin | Refractive |
|---|---|---|---|
| ID | Manufacturer | Component | Index |
| G | Cytec Surface Specialties | Ebecryl 600 | 1.5553 |
| H | Sartomer Company, Inc. | CN 963 A 80 | 1.4818 |
| I | Sartomer Company, Inc. | CN 120 | 1.5556 |
| J | Cytec Surface Specialties | RDX 51027 | ˜1.60 |
| K | Sartomer Company, Inc. | SR 601 | 1.5340 |
| L | Sartomer Company, Inc. | SR 349 | 1.5425 |
| M | Sartomer Company, Inc. | SR 351 | 1.4723 |
| N | Ciba Specialty Chemicals | Darocur 1173 | 1.5286 |
| | Corp. | | |

All of the components in Table II, with the exception of Darocur 1173 (photoinitiator) are photopolymerizable resins that cross-link upon curing. CN963A80 is a urethane acrylate oligomer blended with tripropylene glycol diacrylate. CN120 is an epoxy acrylate oligomer. Ebecryl 600 is a Bisphenol-A epoxy diacrylate oligomer. SR601 and SR349 are ethoxylated Bisphenol-A diacrylates. SR351 is trimethylol propane triacrylate, and SR306 is tripropylene glycol diacrylate. RDX 51027 is an oligomeric brominated epoxy acrylate.

Cytec Surface Specialties is located in Brussels, Belgium, Sartomer Company, Inc. is located in Exton, Pa. and Ciba Specialty Chemicals Corp. is located in Tarrytown, N.Y. The refractive indices of the Sartomer material were obtained from the manufacturer's literature. The refractive indices for the other materials were measured using the ABBE Mark II Digital Refractometer (589.3 nm wavelength) at 20° C. RDX 51027 is a solid at 20° C., so the refractive index is estimated by back calculating from a measured resin composition with other known component refractive indices.

### EXAMPLE 1

Resin Composition 1 was formed using the following components: 74.20% wt. component H, 24.82 % wt. component M and 0.986% wt. component N. The refractive index of Resin Composition 1 (before curing) was measured as 1.4824 on an ABBE Mark II Digital Refractometer at 20° C. and wavelength 589.3 nm. The refractive index of Resin Composition 1 after curing (with no fibers) was measured as 1.5019 on a Metricon Model 2010 Prism Coupler at wavelength 632.8 nm. The magnitude of the difference between the refractive index of the cured polymer and the embedded fiber, Δn, was 0.0461.

The composite of Example 1 was prepared by taking a piece of Material A, approximately 75 mm×75 mm in size, and placing it onto a 100 μm (4 mil) thick sheet of polyester that was on a 4.7 mm ( 3/16″) thick float glass sheet. The resin of Composition 1 was heated to approximately 70° C. in a microwave oven. Approximately 1.8 grams of the warm resin were placed in the center of the fiberglass sheet, and a second sheet of 100 μm thick polyester was placed on top, and a second piece of 4.7 mm thick float glass was placed on top of the second sheet of polyester. The combination of the glass, polyester, resin, and fiber is referred to as the resin sandwich.

The resin sandwich was placed into a vacuum oven at 89° C. and at a pressure of 699 mm Hg for 8 minutes to de-gas the resin and fiberglass to reduce the amount of bubbles before curing the composite.

After the resin sandwich was removed from the vacuum oven, two 200 μm (0.008″) feeler gages were placed between the two sheets of polyester film on two opposite ends of the resin sandwich and two binder clips were used on each of these two ends to clamp the resin sandwich together and to establish the resin sandwich thickness. The resin sandwich was then cured by placing it on a moving belt running at about 9.1 meters (30 feet) per minute beneath a Fusion F600 D lamp with a dichroic reflector, and a power setting of 100%. The resulting measured energy density was measured with a PowerMAP from EIT (Sterling, Va.), and is presented in Table III. Three individual measurements were taken at the same conditions and the average energy density is presented.

TABLE III
Measured Energy Density F600 D lamp with dichroic
reflector at 100% power and 9.1 meters per minute.

| | Average energy density |
|---|---|
| Wavelength Range | (mJ cm⁻²) |
| UVA | 1581 |
| UVB | 433 |
| UVC | 34 |
| UVV | 953 |

The resulting cured composite was removed from the glass and polyester film. The measured optical properties for Composite 1 are listed in Table IV.

### EXAMPLE 2

Resin Composition 2 was formed using the following components: 30.01 % wt. component H; 54.92 % wt. component G, 14.06 % wt. component L, 1.01 % wt. component N. The refractive index of Composition 2 (before curing) was measured as 1.5336 on the ABBE Mark II Digital Refractometer at 20° C. and at a wavelength of 589.3 nm. The refractive index of Composition 2 after curing (with no fibers) was measured as 1.5451 on the Metricon Model 2010 Prism Coupler at wavelength 632.8 nm. The magnitude of the difference between the refractive index of the cured polymer and the embedded fiber, Δn, was 0.0029.

The composite of Example 2 was prepared using the same fiberglass as in Example 1 (Material A) and Resin Composition 2. The preparation of this composite followed the same procedure and conditions as described in Example 1. The resulting measured optical properties for Composite 2 are listed in Table IV.

### EXAMPLE 3

Resin Composition 3 was formed using the following components: 29.79 % wt. component H; 48.85 % wt. component G, 5.07 wt% component K; 15.25 % wt. component L; 1.04 % wt. component N. The refractive index of Composition 3 (before curing) was measured to be 1.5315 at 20° C. and at a wavelength of 589.3 nm. The refractive index after curing (with no fiber) was measured to be 1.5451 at a wavelength of 632.8 nm. The magnitude of the difference between the refractive index of the cured polymer and the embedded fiber, Δn, was 0.0029.

The Composite of Example 3 was prepared using the same fiberglass as in Example 1 (Material A) and Composition 3. The preparation of this composite followed the same procedure and conditions as described in Example 1, except that time in the vacuum oven was 19 minutes instead of 8 minutes. The resulting measured optical properties for Composite 3 are listed in Table IV.

### EXAMPLE 4

Resin Composition 4 was formed using the following components: 74.17 % wt. component H; 24.83 % wt. component L, 1.00 % wt. component N. The refractive index of Composition 4 (before curing) was measured to be 1.4998 at 20° C. and at a wavelength of 589.3 nm. The refractive index after curing (with no fibers) was measured to be 1.5140 at a wavelength of 632.8 nm. The magnitude of the difference between the refractive index of the cured polymer and the embedded fiber, Δn, was 0.054.

The Composite of Example 4 was prepared by taking a piece of Nextel 312 ceramic 2-inch tape (Material F), approximately 50 mm×63 mm in size, and placing it onto a 100 μm thick sheet of polyester backed by a piece of 4.7 mm thick float glass. The resin of Composition 4 was heated to approximately 70° C. in a microwave oven. Approximately 2.9 grams of the warm resin were placed in the center of the ceramic fiber sheet, and a second sheet of 100 μm thick polyester was placed on top, and a second piece of 4.7 mm thick float glass was placed on top of the second sheet of polyester. The combination of the glass, polyester, resin, and Nextel tape is referred to as the resin sandwich.

The resin sandwich was placed into a vacuum oven at 60° C. and 699 mm Hg for 10 minutes to de-gas the resin and fiber and to reduce the amount of bubbles before curing the composite. No feeler gages or binder clips were used to clamp the resin sandwich together. The resin sandwich was then cured as described in Example 1. The resulting cured composite was removed from the glass and polyester film. The measured optical properties for Composite 4 are listed in Table IV.

### EXAMPLE 5

Resin Composition 5 was formed using the following components: 74.25 % wt. component K; 24.74% component I, 1.02 % wt. component N. The refractive index of Composition 5 (before curing) was measured to be 1.5420 at 20° C. and at a wavelength of 589.3 nm. The refractive index after curing (with no fibers) was measured to be 1.5597 at a wavelength of 632.8 nm. The magnitude of the difference between the refractive index of the cured polymer and the embedded fiber, Δn, was 0.0083.

The Composite of Example 5 was prepared using Nextel 312 ceramic 2-inch tape (Material F) and Resin Composition 5. The preparation of this composite followed the same procedure and conditions as described in Example 4, except that the amount of resin used was 3.0 grams and the time in the vacuum oven was 8 minutes. The resulting measured optical and mechanical properties for Composite 5 are listed in Tables IV and V.

### EXAMPLE 6

Resin Composition 6 was formed using the following components: 49.46 % wt. component J; 49.56% wt. component L, 0.99 % wt. component N. The refractive index of Composition 6 (before curing) was measured to be 1.5682 at 20° C. and at a wavelength of 589.3 nm. The refractive index after curing (with no fibers) was measured to be 1.5821 at a wavelength of 632.8 nm. The magnitude of the difference between the refractive index of the cured polymer and the embedded fiber, Δn, was 0.0141.

The Composite of Example 6 was prepared using Nextel 312 ceramic 2-inch tape (Material F) and Resin Composition 6. The preparation of this composite followed the same procedure and conditions as described in Example 4, except that the amount of resin used was 3.0 grams, the temperature of the vacuum oven was 89° C., and the time in the vacuum oven was 8 minutes. The resulting measured optical properties for Composite 6 are listed in Table IV.

### EXAMPLE 7

Resin Composition 7 was formed using the following components: 39.59 % wt. component J; 59.41 % wt. component L, 0.99 % wt. component N. The refractive index of Composition 7 (before curing) was measured to be 1.5574 at 20° C. and at a wavelength of 589.3 nm. The refractive index after curing (with no fibers) was measured to be 1.5766 at a wavelength of 632.8 nm. The magnitude of the difference between the refractive index of the cured polymer and the embedded fiber, Δn, was 0.086.

The Composite of Example 7 was prepared using Nextel 312 ceramic 2-inch tape (Material ID F) and Resin Composition 7. The preparation of this composite followed the same procedure and conditions as described in Example 4, except that the amount of resin used was 2.96 grams and the temperature of the vacuum oven was 70° C. The resulting measured optical properties for Composite 7 are listed in Table IV.

### EXAMPLE 8

The resin composition used for Example 8 was the same as that listed for Example 1. A composite was prepared using Material B and Resin Composition 1. The magnitude of the difference between the refractive index of the cured polymer and the embedded fiber, Δn, was 0.0471.

The preparation of this composite followed the same procedure and conditions as described in Example 1, except the amount of resin used was 1.7 grams and the resin sandwich was cooled before it was taken apart. The resulting measured optical properties for Composite 8 are listed in Table IV.

### EXAMPLE 9

The resin composition used for Example 9 was the same as that listed for Example 3. A composite was prepared using Material B fibers and Resin Composition 3. The magnitude of the difference between the refractive index of the cured polymer and the embedded fiber, Δn, was 0.0039. The preparation of this composite followed the same procedure and conditions as described in Example 1, except the amount of resin used was 1.9 grams. The resulting measured optical properties for Composite 9 are listed in Table IV.

### EXAMPLE 10

Resin Composition 10 was formed using the following components: 31.07 % wt. component H; 50.66 % wt. component G; 2.63 % wt. component K; 14.64 % wt. component L and 1.00 % wt. component N. The refractive index of Composition 10 (before curing) was measured to be 1.5299 at 20° C. and at a wavelength of 589.3 nm. The refractive index after curing (with no fibers) was measured to be 1.5444 at a wavelength of 632.8 nm. The magnitude of the difference between the refractive index of the cured polymer and the embedded fiber, Δn, was 0.0046.

The Composite of Example 10 was prepared using the same fibers as in Example 8 (Material B) and Resin Composition 10. The preparation of this composite followed the same procedure and conditions as described in Example 1. The resulting measured optical and mechanical properties for Composite 10 are listed in Tables IV and V.

### EXAMPLE 11

Resin Composition 11 was formed using the following components: 18.05 % wt. component H; 35.93 % wt. component G; 22.06 % wt. component K; 22.96 % wt. component L and 1.00 % wt. component N. The refractive index of Composition 11 (before curing) was measured to be 1.5371 at 20° C. and at a wavelength of 589.3 nm. The refractive index after curing (with no fibers) was measured to be 1.5519 at a wavelength of 632.8 nm. The magnitude of the difference between the refractive index of the cured polymer and the embedded fiber, Δn, was 0.0001.

The Composite of Example 11 was prepared using Material D and Resin Composition 11. The preparation of this composite followed the same procedure and conditions as described in Example 1. The resulting measured optical and mechanical properties for Composite 11 are listed in Tables IV and V.

### EXAMPLE 12

The resin composition used for Example 12 was the same as that listed for Example 11. A composite was prepared using Material E and Resin Composition 11. The preparation of this composite followed the same procedure and conditions as described in Example 1, except the amount of resin used was 1.9 grams. The magnitude of the difference between the refractive index of the cured polymer and the embedded fiber, Δn, was 0.0021. The resulting measured optical properties for Composite 12 are listed in Table IV.

### EXAMPLE 13

The resin composition used for Example 13 was the same as that listed for Example 11. A composite was prepared using Material C and Resin Composition 11. The preparation of this composite followed the same procedure and conditions as described in Example 1. The magnitude of the difference between the refractive index of the cured polymer and the embedded fiber, Δn, was 0.0001. The resulting measured optical and mechanical properties for Composite 13 are listed in Tables IV and V.

### EXAMPLE 14

Resin Composition 14 was formed using the following components: 17.03 % wt. component H; 41.98 % wt. component G; 39.99 % wt. component K; and 1.00 % wt. component N. The refractive index of Composition 10 (before curing) was measured to be 1.5359 at 20° C. and at a wavelength of 589.3 nm. The magnitude of the difference between the refractive index of the cured polymer and the embedded fiber, Δn, was 0.0004. The refractive index after curing (with no fibers) was measured to be 1.5516 at a wavelength of 632.8 nm.

The Composite of Example 14 was prepared using Material C and Resin Composition 14. The preparation of this composite followed the same procedure and conditions as described in Example 1, except the resin sandwich was cooled before it was taken apart. The resulting measured optical properties for Composite 14 are listed in Table IV.

### EXAMPLE 15

Resin Composition 15 was formed using the following components: 21.48 % wt. component H; 44.67 % wt. component G; 22.26 % wt. component K; 10.57 % wt. component L and 1.00 % wt. component N. The refractive index of Composition 10 (before curing) was measured to be 1.5356 at 20° C. and at a wavelength of 589.3 nm. The refractive index after curing (with no fibers) was measured to be 1.5505 at a wavelength of 632.8 nm. The magnitude of the difference between the refractive index of the cured polymer and the embedded fiber, Δn, was 0.0015.

The Composite of Example 15 was prepared using Material C and Resin Composition 15. The preparation of this composite followed the same procedure and conditions as described in Example 1. The resulting measured optical properties for Composite 15 are listed in Table IV.

Examples 16-21 relate to samples of cured polymer that did not include fiber reinforcement.

### EXAMPLE 16

In Composite 14, described in Example 14, there was an area of excess resin extending beyond the edge of the fiber reinforcement prior to curing. After curing, this area had solidified as a free-standing film. This section of Composite 14, free of fiber reinforcement, was analyzed as Example 16. All the relevant sample preparation information for Example 16 is described in Example 14. The measured optical properties for the resin of Example 16 are listed in Table IV.

### EXAMPLE 17

The resin composition for Example 17 was formed using the following components: 30.08 % wt. component H; 54.83 % wt. component G; 14.08 % wt. component K; and 1.00 % wt. component N. The refractive index of the resin, before curing, was measured to be 1.5323 at 20° C. and at a wavelength of 589.3 nm. The refractive index after curing (with no fiber) was measured to be 1.5452 at a wavelength of 632.8 nm.

The composite of Example 17 was prepared using the same fiberglass as in Example 8 (Material B) and resin with composition listed for Comparative Example 2. The preparation of this composite followed the same procedure and conditions as described in Example 1. There was an area of excess resin outside the fiberglass reinforcement after the sample was cured. The data for Example 17 were generated by analyzing the solidified resin that extended beyond the fiberglass reinforcement. The measured optical properties for the resin of Example 17 are listed in Table IV.

### EXAMPLE 18

Example 18 data were generated by analyzing a portion of the Composite of Example 2, in which there was excess resin as the sample was created. Prior to resin curing in Example 2, excess resin extended beyond the edge of the fiberglass reinforcement, creating an area of resin only, without fiber reinforcement. After curing, that area had solidified as a free-standing film. This section of solidified resin, containing no fiberglass reinforcement, was analyzed to produce the data for Example 18. Thus, all the sample preparation information for Example 18 is described as for Example 2. The measured optical properties for the resin of Example 18 are listed in Table IV.

### EXAMPLE 19

The cured resin sample for Example 19 was prepared by heating the resin (of the same composition as that listed in Example 10) to approximately 60° C. in a microwave oven and pouring approximately 1-2 grams in the center of a 100 μm thick sheet of polyester that was placed on top of a 6 mm (¼″) metal plate. Two spacers, each about 0.43 mm, thick were placed on each side of the resin about 50-75 mm (2″-3″) apart so that the resin would not touch the spacers after it was flattened. A second sheet of 100 μm thick polyester was placed on top of the resin and the spacers. The metal plate with the resin and spacers between two sheets of polyester film was run through a manually operated laminator to press the resin flat. The combination of the metal plate, polyester, and resin is referred to as the modified resin sandwich. The modified resin sandwich was then cured by the same method described in Example 1. The measured optical and mechanical properties for the resin of Example 19 are listed in Tables IV and V.

### EXAMPLE 20

The cured resin sample for Example 20 was prepared in an identical manner to the cured resin sample of Example 19, with the exception that the resin had the same composition as that listed for Example 11. The resulting measured optical and mechanical properties for the resin of Example 20 are listed in Tables IV and V.

### EXAMPLE 21

The cured resin sample for Example 21 was prepared by heating the resin composition of Example 5 to approximately 50° C. in a microwave oven and pouring approximately 1-2 grams in the center of a 100 μm thick sheet of polyester on top of a 4.7 mm ( 3/16″) thick sheet of float glass. Two spacers, each about 0.43 mm thick were placed on each side of the resin, about 50 mm-75 mm (2″-3″) apart so that the resin would not touch the spacers after it was flattened. A second sheet of 100 μm thick polyester was placed on top, and a second piece of 4.7 mm ( 3/16″) thick float glass was placed on top of the second sheet of polyester. The two pieces of glass were gently squeezed together where the two spacers were placed to produce the desired thickness of resin. The combination of the glass, polyester, and resin is referred to as the resin sandwich. The resin sandwich was then cured by the same method described in Example 1. The resulting measured optical and mechanical properties for the resin of Example 21 are listed in Tables IV and V.

The different example composites were tested for optical transmission, reflection, haze and color. Haze (H) and clarity (C) measurements were made using a BYK Gardner Haze-Gard Plus instrument, catalog no. 4723 and supplied by BYK Gardner, Silver Spring, Md. The transmission and haze levels were collected according to ASTM-D1003-00, titled “Standard Test Method for Haze and Luminous Transmittance for Transparent Plastics”. The instrument was referenced against air during the measurements. Light transmission (T) measurements are provided as a percentage of transmission. Haze is the scattering of light by a specimen responsible for the reduction in contrast of objects viewed through it. Haze, H, is presented as the percentage of transmitted light that is scattered so that its direction deviates more than a specified angle from the direction of the incident beam. In this test method, the specified angle is 2.5°. Clarity, C, is presented as the percentage of transmitted light that is scattered so that its direction deviates less than 2.5°.

The color in 1976 CIE L*a*b*color space was measured using a BYK Gardner Colorsphere (Cat. No. 6465,). The testing procedure was similar to that described in ASTM E1164: Obtaining Spectrometric Data for Object-Color Evaluation. The instrument was calibrated to calculate the color shift of the sample from air.

Light transmission (% T) and reflection (% R) measurements were made using a Perkin-Elmer Lambda 900 Spectrophotometer (Model: BV900ND0) fitted with a PELA-1000 integrating sphere accessory over the 400-700 nm range. This sphere is 150 mm (6 inches) in diameter and complies with ASTM methods E903, D1003, E308, et al. as published in “ASTM Standards on Color and Appearance Measurement”, Third Edition, ASTM, 1991. The instrument was referenced against air during the measurement. The scan speed of the spectrophotometer was ˜1250 nm/minute with a UV-Visible integration of 120 ms/pt. The data interval and resolution were 5 nm. Transmission and reflection data are presented as percentages as measured at 550 nm.

The thickness of each sample was measured at four different points. The data under the column marked (t) shows the range in the measured thickness in microns.

TABLE IV
Summary of Optical Properties of Composites of Examples 1-15

| | | BYK Haze-Gard | | BYK ColorSphere | | | Lambda 900 | |
|---|---|---|---|---|---|---|---|---|
| Example | t (μm) | H | C | L* | a* | b* | % T @ 550 nm | % R @ 550 nm |
| 1 | 70-103 | 48.6 | 82.7 | 96.42 | 0.11 | 0.47 | 92.22 | 7.80 |
| 2 | 122-148 | 2.2 | 99.1 | 96.37 | −0.08 | 0.58 | 91.04 | 8.51 |
| 3 | 85-113 | 2.9 | 98.2 | 96.38 | −0.04 | 0.43 | 91.09 | 8.57 |
| 4 | 444-480 | 96.3 | 30.8 | 87.41 | 0.53 | 4.63 | 71.74 | 25.36 |
| 5 | 413-451 | 72.3 | 40.7 | 85.05 | 0.37 | 5.00 | 67.10 | 28.66 |
| 6 | 470-538 | 73.4 | 42.9 | 85.18 | 0.20 | 5.92 | 68.32 | 27.12 |
| 7 | 409-447 | 66.9 | 45.9 | 84.94 | 0.23 | 5.37 | 66.61 | 28.67 |
| 8 | 56-137 | 52.0 | 81.2 | 96.03 | 0.20 | 0.56 | 92.20 | 7.73 |
| 9 | 103-167 | 2.6 | 99.1 | 96.34 | −0.07 | 0.47 | 91.05 | 8.42 |
| 10 | 112-171 | 2.5 | 99.0 | 96.36 | −0.09 | 0.51 | 91.20 | 8.30 |
| 11 | 137-175 | 4.2 | 96.2 | 95.94 | −0.07 | 0.83 | 89.78 | 9.30 |
| 12 | 144-149 | 16.5 | 90.0 | 94.86 | −0.05 | 0.92 | 87.80 | 11.07 |
| 13 | 87-126 | 5.6 | 98.0 | 95.94 | −0.01 | 0.71 | 90.25 | n/a |
| 14 | 90-123 | 3.7 | 98.4 | 96.18 | −0.04 | 0.62 | 90.32 | 8.87 |
| 15 | 110-128 | 5.5 | 98.3 | 96.13 | −0.04 | 0.60 | 90.25 | 8.89 |
| 16 | 54-63 | 0.3 | 99.7 | 96.57 | −0.02 | 0.26 | 90.90 | 8.69 |
| 17 | 119-154 | 0.5 | 99.7 | 96.53 | 0 | 0.31 | 91.14 | 8.69 |
| 18 | 90-125 | 0.4 | 100 | 96.69 | 0.05 | 0.42 | 91.10 | 8.51 |
| 19 | 132-169 | 0.3 | 99.7 | 96.62 | −0.04 | 0.41 | 91.05 | 8.56 |
| 20 | 111-129 | 0.3 | 99.7 | 96.55 | −0.01 | 0.31 | 90.73 | 8.74 |
| 21 | 419-426 | 0.5 | 99.7 | 96.43 | −0.04 | 0.55 | 90.90 | 8.79 |

Good refractive index matching was obtained in many examples, with the reflective index difference being less than 0.005 in Examples 2, 3, and 9-15, and less than around 0.0002 for Examples 1 1 and 13. Examples 2, 3, 9, and 10 had a haze value of less than 3% and high transmission. To the naked eye these films were very clear.

Examples 4-7, using the ceramic fibers, had a minimum refractive index difference between the matrix and the fiber of at least 0.008 and the fibers were presented in the form of a tight weave. The tightness of the weave made it difficult to ensure that all the bubbles were removed form the polymer/fiber interfaces before curing. As a result, the haze value of these samples was relatively high. Lower haze values may be achieved by achieving better elimination of bubbles from the fiber and resin before solidification and by achieving a better index-matching matrix.

Mechanical characteristics of some of the samples were measured. The measurements included the coefficient of thermal expansion (CTE) and the storage modulus. The results of these measurements are listed in Table V. The CTE was measured using a Perkin Elmer Thermomechanical Analyzer, TMA-7 with film tension geometry. Temperature sweep experiments were performed in expansion mode over the range of 20° C. up to 150° C. at 10° C./min. The CTE listed in Table V is the CTE over the range of 70° C.-120° C., which was found in all cases to be substantially linear over the temperature range. The CTE is listed in the table as parts per million per degree Celcius (ppm/° C.) and was measured for the second heating cycle of the samples. The CTE is presented in the form x/y for those samples containing fibers. The fibers were in the samples in the form of a weave, with the fibers lying in the (arbitrarily assigned) x- and y-directions. The CTE is listed for expansion in the x- and y-directions. The density of the fibers in the x- and y-directions was not equivalent in Example 10, which resulted in the markedly different values of CTE in the x- and y-directions. In examples 10, 11 and 13, the fiber was in the form of a weave with approximately similar fiber density in the x- and y-directions. No fibers were present in Examples 19-21, and so only one CTE is listed for these samples.

The storage (elastic) modulus of a film sample was measured using a TA Instruments Q800 series Dynamic Mechanical Analyzer (DMA) with film tension geometry. Temperature sweep experiments were performed in dynamic strain mode over the range of −40° C. up to 200° C. at 2° C./min. The storage modulus and tan delta (loss factor) were reported as a function of temperature. The storage modulus is listed in Table V for three different temperatures, viz. 24° C., 66° C. and 100° C. The peak of the tan delta curve was used to identify the glass transition temperature, Tg, for the films. For examples 10 and 21 the value of Tg was measured in a second heating cycle of the respective samples.

TABLE V
Mechanical Characteristics of Example Films

| | | Sto. Mod. | Sto. Mod. | Sto. Mod. | |
|---|---|---|---|---|---|
| Example | CTE (x/y) | (24° C.) | (66° C.) | (100° C.) | Tg |
| No. | (ppm/° C.) | (GPa) | (GPa) | (GPa) | (° C.) |
| 5 | 22.4/16.1 | 14.46 | 11.31 | 5.69 | 92 |
| 10 | 27.5/28.0 | 5.37 | 2.82 | 1.41 | 82 |
| 11 | 24.0/24.1 | — | — | — | — |
| 13 | 25.3/24.1 | — | — | — | — |
| 19 | 174.6 | 5.32 | 0.606 | 0.034 | 82 |
| 20 | 159.7 | 2.76 | 0.668 | 0.040 | 83 |
| 21 | 197.3 | 2.34 | 0.187 | 0.040 | 74 |

The CTE of the fiber-reinforced examples was significantly less than that of the unreinforced examples, regardless of whether the fiber was glass or glass-ceramic. In addition, the storage modulus of the fiber reinforced examples was significantly higher than for the unreinforced examples, particularly at the elevated temperature of 66° C., which is within the expected operating range for several different types of display applications. The higher storage modulus of the fiber-reinforced composite film samples is believed to reduce the amount of warping or sagging of the film at elevated operating temperatures, increase the stiffness of the films and result in more stable, long-term utility.

In some embodiments it may be desired that the value of Tg be less than 135° C., and maybe less than 100° C. The use of polymer materials having values of Tg in these ranges results in having a wide selection of possible materials to use and provides for less expensive and more processable materials than if materials having higher values of Tg are used. Note that the values of Tg for Examples 5 and 10 are 92° C. and 82° C. respectively.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An optical body, comprising:
a polymer matrix, the polymer matrix having a first refractive index; and
a plurality of fibers embedded within the polymer matrix, the fibers being formed of a fiber material comprising at least one of a glass-ceramic and a ceramic, the fiber material having a second refractive index that is substantially the same as the first refractive index.

2. An optical body as recited in claim 1, wherein the polymer matrix is birefringent, the polymer matrix having a third refractive index different from the first refractive index.

3. An optical body as recited in claim 1, wherein the polymer matrix is substantially isotropic.

4. An optical body as recited in claim 1, wherein the fibers are arranged in tows within the polymer matrix.

5. An optical body as recited in claim 1, wherein the fibers are arranged as at least one fiber weave within the polymer matrix.

6. An optical body as recited in claim 5, wherein the fibers are included within at least one of the warp and the weft of the fiber weave, and at least one of the warp and the weft of the fiber weave comprises at least one of polymer fibers and natural fibers.

7. An optical body as recited in claim 6, wherein the polymer fibers comprise birefringent polymer material.

8. An optical body as recited in claim 1, wherein the fibers are embedded within the polymer matrix without a binding agent to bind the fibers to the matrix.

9. An optical body as recited in claim 1, wherein at least one of the fibers is formed in a yarn with one or more polymeric fibers.

10. An optical body as recited in claim 9, wherein the yarn is formed with a centrally positioned fiber and two or more polymeric fibers twisted around the centrally positioned fiber, the centrally positioned fiber being a glass-ceramic or a ceramic fiber.

11. An optical body as recited in claim 1, wherein the body comprises at least one structured surface.

12. An optical body as recited in claim 11, wherein the structured surface provides optical power to light passing through the optical body.

13. An optical body as recited in claim 12, wherein the structured surface comprises at least one lens.

14. An optical body as recited in claim 11, wherein the at least one structured surface comprises an array of prismatic structures.

15. An optical body as recited in claim 1, further comprising an additive within the polymer matrix, the additive effectively adjusting the refractive index of the polymer matrix.

16. An optical body as recited in claim 1, further comprising an additive within the polymer matrix, the additive effectively increasing the strength of the polymer matrix.

17. An optical body as recited in claim 1, further comprising light diffusing particles within the polymer matrix.

18. An optical body as recited in claim 1, wherein the polymer matrix comprises a UV-cured acrylate.

19. An optical body as recited in claim 1, wherein the polymer matrix comprises a cross-linkable material.
